(19) United States
(12) Patent Application Publication
(10) Pub. No.: US 2013/0173647 A1
(43) Pub. Date: Jul. 4, 2013

(54) STRING MATCHING DEVICE BASED ON MULTI-CORE PROCESSOR AND STRING MATCHING METHOD THEREOF

(71) Applicants: Won Woo Ro, Seoul (KR); Doohwan Oh, Seoul (KR)

(72) Inventors: Won Woo Ro, Seoul (KR); Doohwan Oh, Seoul (KR)

(73) Assignee: Industry-Academic Cooperation Foundation, Yonsei University, Seoul (KR)

(21) Appl. No.: 13/819,767

(22) PCT Filed: Dec. 30, 2010
(86) PCT No.: PCT/KR2010/009544

§ 371 Date: Feb. 28, 2013

(30) Foreign Application Priority Data
Aug. 31, 2010 (KR) 10-2010-0084923

(51) Int. Cl. G06F 7/20

(52) U.S. Cl. CPC G06F 7/20
USPC 707/758

(57) ABSTRACT

The inventive concept relates to string matching device and method based on a multi-core processor. A string matching method according to an embodiment of the inventive concept includes sorting patterns based on a suffix block; allocating the sorted patterns to pattern storage units of respective cores; and executing string matching on a target text using patterns stored at the pattern storage unit. By the string matching device and method according to an embodiment of the inventive concept, there may increase availability on hardware resources based on a multi-core processor. Also, it is possible to reduce computation for string matching by performing pre-processing on sorted patterns. Thus, it is possible to reduce an execution time of a string matching operation.

### TECHNICAL FIELD

The inventive concepts described herein relate to string matching device and method, and more particularly, relate to a string matching device based on a multi-core processor and a string matching method.

### BACKGROUND ART

A string matching algorithm may be recognized as an efficient algorithm which searches a specific pattern at database including much information. For example, the string matching algorithm may provide an efficient method for searching a specific pattern at human genome project, virus analysis, a firewall system of a computer network, and so on.

A Wu-Manber algorithm may be known as the string matching algorithm. The Wu-Manber algorithm may generate a shift table, a hash table, and a prefix table at pre-processing. The Wu-Manber algorithm may determine whether a text includes a specific pattern, using tables generated at pre-processing.

Meanwhile, application of a multi-core processor may be emphasized due to a limit to the performance of a single-core processor. More particularly, in the field of computer science or engineering, importance of the multi-core processor may gradually increase. Thus, there is required a string matching method using the multi-core processor.

### DETAILED DESCRIPTION OF INVENTION

### Technical Problem

The present invention provides string matching device and method capable of reducing computation on the basis of a multi-core processor.

### Technical Solution

A string matching method according to an embodiment of the inventive concept is based on a multi-core processor. The string matching method comprises sorting patterns based on a suffix block; allocating the sorted patterns to pattern storage units of respective cores; and executing string matching on a target text using patterns stored at the storage unit.

In example embodiments, in the executing string matching, the string matching is executed by a Wu-Manber algorithm.

In example embodiments, the executing string matching comprises executing pre-processing on patterns stored at each pattern storage unit; and executing the string matching on the target text referring to tables generated at the pre-processing.

In example embodiments, the executing pre-processing comprises generating a shift table. When the shift table is generated, a shift value is set to ‘0’ on a combination of the same characters as a suffix block of patterns stored at each pattern storage unit.

In example embodiments, in the executing pre-processing, the pre-processing is processed in parallel by the respective cores.

In example embodiments, in the executing string matching, the string matching is processed in parallel by the respective cores.

In example embodiments, in the sorting patterns, the patterns are sorted according to lexicographic order of characters included in the suffix block.

A string matching method according to another embodiment of the inventive concept is based on a multi-core processor, and comprises sorting patterns according to lexicographic order based on characters include in a suffix block; allocating the sorted patterns to pattern storage units of respective cores; executing pre-processing on patterns stored at a pattern storage unit; and executing string matching on a target text referring to tables generated at the pre-processing.

In example embodiments, in the executing pre-processing and the executing string matching, the pre-processing and the string matching are executed by a Wu-Manber algorithm.

In example embodiments, in the executing pre-processing and the executing string matching, the pre-processing and the string matching are processed in parallel by the cores.

A string matching device according to an embodiment of the inventive concept comprises a pattern sorting module configured to sort patterns based on a suffix block; first and second pattern storage units configured to store the sorted patterns; and first and second pattern matching units corresponding to the first and second pattern storage units and configured to perform string matching on a target text using patterns stored at the first and second pattern storage units, respectively.

In example embodiments, the string matching device further comprises a shared data storage module configured to store the target text. The first and second pattern storage units access the shared data storage module to read the target text.

In example embodiments, the first and second pattern matching units execute the string matching using a Wu-Manber algorithm.

In example embodiments, the first and second pattern matching units perform pre-processing on patterns stored at the first and second pattern storage units, respectively, to generate a shift table, a hash table and a prefix table.

In example embodiments, when the shift table is generated, each of the first and second pattern matching units sets a shift value ‘0’ on a combination of the same characters as a suffix block of patterns stored at a corresponding one of the first and second pattern storage units.

In example embodiments, the pre-processing and the string matching are processed in parallel by the first and second pattern matching units.

In example embodiments, the first and second pattern matching units are implemented by a multi-core processor.

In example embodiments, the pattern sorting module sorts the patterns according to lexicographic order of characters included in the suffix block.

In example embodiments, the target text is a genome gene sequence.

In example embodiments, a size of the suffix block is 2.

### Advantageous Effects

By string matching device and method according to an embodiment of the inventive concept, there may increase availability on hardware resources based on a multi-core processor. Also, it is possible to reduce computation for string matching by performing pre-processing on sorted patterns. Thus, it is possible to reduce an execution time of a string matching operation.

### DESCRIPTION OF DRAWINGS

FIG. 1 is a block diagram schematically illustrating a string matching device according to an embodiment of the inventive concept.

FIG. 2 shows patterns before and after sorting based on a suffix block.

FIG. 3 is a diagram illustrating string matching on sorted patterns.

FIG. 4 is a diagram illustrating string matching on unsorted patterns.

FIG. 5 is a flow chart illustrating a string matching method according to an embodiment of the inventive concept.

FIG. 6 is a block diagram illustrating a multi-core processor according to an embodiment of the inventive concept.

FIG. 7 is a block diagram illustrating a multi-core processor according to another embodiment of the inventive concept.

### MODE FOR INVENTION

The present invention will now be described in detail with reference to the accompanying drawings, in which preferred embodiments of the invention are shown.

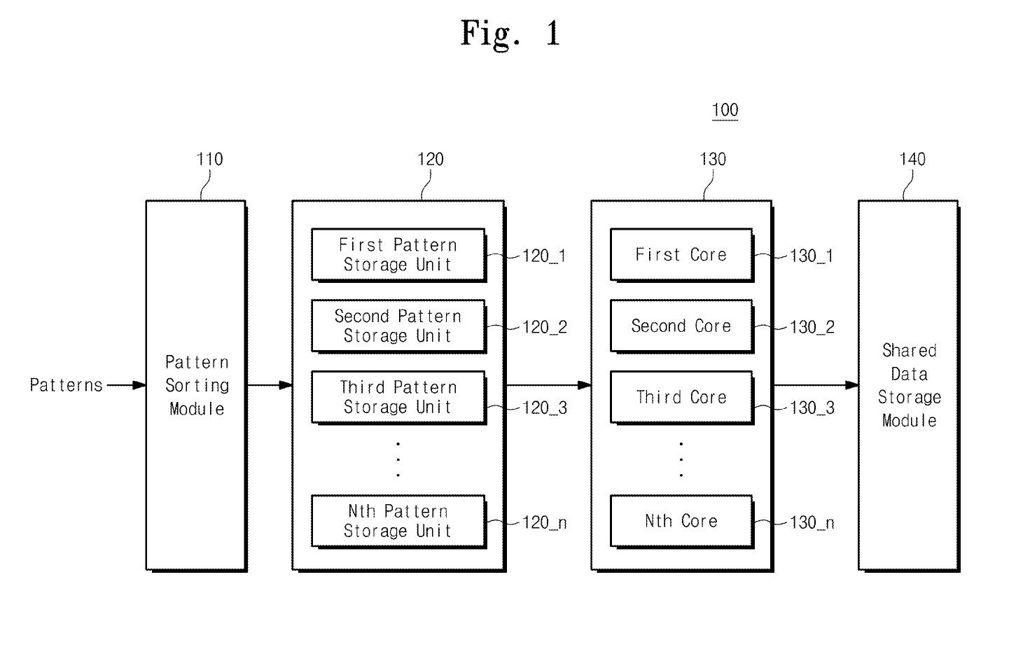

FIG. 1 is a block diagram schematically illustrating a string matching device according to an embodiment of the inventive concept. Referring to FIG. 1, a string matching device 100 may be based on a multi-core processor. The string matching device 100 may include a pattern sorting module 110, a pattern storage module 120, a multi-core processor 130, and a shared data storage module 140.

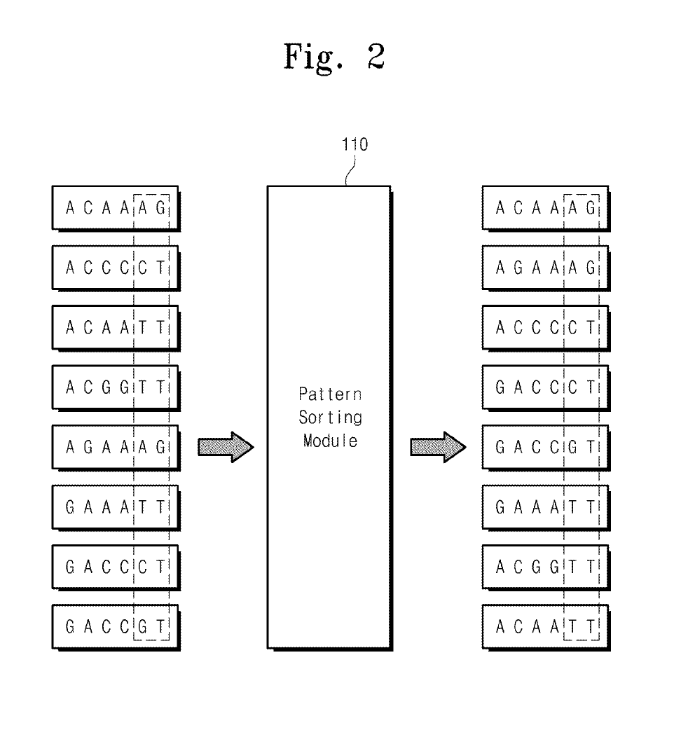

The pattern sorting module 110 may sort patterns according to lexicographic order based on a suffix block of the patterns. Herein, the suffix block may mean n characters from the rear of characters in a pattern when a size of the suffix block is n. For example, when a pattern is “ACAAAG” and a size of a suffix block is 2, the suffix block may be “AG”. A method of sorting patterns according to lexicographic order based on the suffix block will be more fully described with reference to FIG. 2.

The pattern storage module 120 may include first to nth pattern storage units 120_1 to 120_{—}n. Patterns sorted in the pattern sorting module 110 may be allocated to the first to nth pattern storage units 120_1 to 120_{—}n. At this time, to efficiently use a hardware resource supported by a multi-core processor, patterns may be uniformly allocated to the first to nth pattern storage units 120_1 to 120_{—}n in light of the number of pattern storage units. For example, when the pattern storage module 120 includes two pattern storage units and the number of patterns is 8, the number of patterns to be stored at one pattern storage unit may be 4.

Meanwhile, the pattern storage module 120 may include a cache memory and so on. The cache memory may be formed of a static RAM (SRAM), a dynamic RAM (DRAM), a synchronous DRAM (SDRAM), a flash memory, a phase-charge RAM (PRAM), a magnetic RAM (MRAM), a resistive RAM (RRAM), a ferroelectric RAM (FRAM), and so on.

The multi-core processor 130 may include first to nth cores 130_1 to 130_{—}n. Herein, the first to nth cores 130_1 to 130_{—}n may correspond to the first to nth pattern storage units 120_1 to 120_{—}n, respectively. The first to nth cores 130_1 to 130_{—}n may perform pre-processing on patterns stored in the first to nth pattern storage units 120_1 to 120_{—}n, respectively. Afterwards, the first to nth cores 130_1 to 130_{—}n may perform string matching on a target text referring to a pre-processing result, respectively. That is, the pre-processing and string matching may be processed in parallel by the multi-core processor 130. At this time, the first to nth cores 130_1 to 130_{—}n may access the shared data storage module 140 to read the target text.

The shared data storage module 140 may store the target text provided from database. The target text may include strings to be matched. For example, the target text may be a gene sequence of a human genome project, traffic data of an intrusion detection system (IDS), and so on.

Meanwhile, the shared data storage module 140 may include a cache memory and so on. The cache memory may be formed of a static RAM (SRAM), a dynamic RAM (DRAM), a synchronous DRAM (SDRAM), a flash memory, a phase-charge RAM (PRAM), a magnetic RAM (MRAM), a resistive RAM (RRAM), a ferroelectric RAM (FRAM), and so on.

The string matching device 100 according to an embodiment of the inventive concept may process pre-processing and string matching in parallel based on the multi-core processor 130. Thus, an operating speed may be improved in comparison with a string matching device based on a single-core processor.

Also, to make efficiency of string matching high, the string matching device 100 according to an embodiment of the inventive concept may sort patterns according to lexicographic order based on a suffix block and store sorted patterns at pattern storage units, respectively.

Meanwhile, a structure of the string matching device 100 of FIG. 1 may be exemplary. The string matching device 100 may be configured variously. For example, a multi-core processor may include a plurality of cores, a plurality of pattern storage units, and a shared data storage module.

FIG. 2 shows patterns before and after sorting based on a suffix block. For ease of description, it is assumed that characters of a pattern are formed of alphabet characters and a size of a suffix block of patterns is 2. Referring to FIG. 2, there may be illustrated eight patterns ‘ACAAAG’, ‘ACCCCT’, ‘ACAATT’, ‘ACGGTT’, ‘AGAAAG’, ‘GAAATT’, ‘ACCCCT’, and ‘GACCGT’. Herein, since a size of a suffix block is 2, suffix blocks of the patterns may be ‘AG’, ‘CT’, ‘TT’, ‘TT’, ‘AG’, ‘TT’, ‘CT’, and ‘GT’.

A pattern sorting module 110 may sort patterns according to lexicographic order based on a suffix block. That is, patterns may be sorted according to lexicographic order of characters in a suffix block. For example, patterns ‘ACAAAG’ and ‘AGAAAG’ each having a suffix block ‘AG’ may have the priority higher than patterns ‘ACCCCT’ and ‘GACCCT’ each having a suffix block ‘CT’.

Thus, if patterns are sorted according to lexicographic order based on a suffix block, patterns ‘ACAAAG’ and ‘AGAAAG’ may be sorted in a first rank, patterns ‘ACCCCT’ and ‘GACCCT’ may be sorted in a second rank, a pattern ‘GACCGT’ may be sorted in a third rank, and patterns ‘ACAATT’, ‘ACGGTT’, and ‘GAAATT’ may be sorted in a fourth rank. When patterns are sorted according to lexicographic order based on a suffix block, patterns determined to be the same rank may be sorted in a random order. Also, when patterns are sorted according to lexicographic order based on a suffix block, sorting between patterns determined to be the same rank may be performed according to lexicographic order based on all characters constituting each pattern.

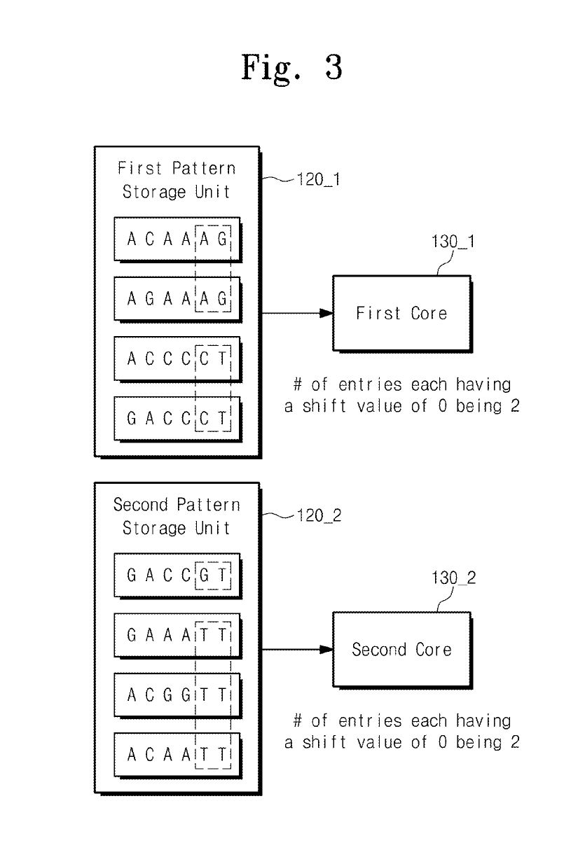

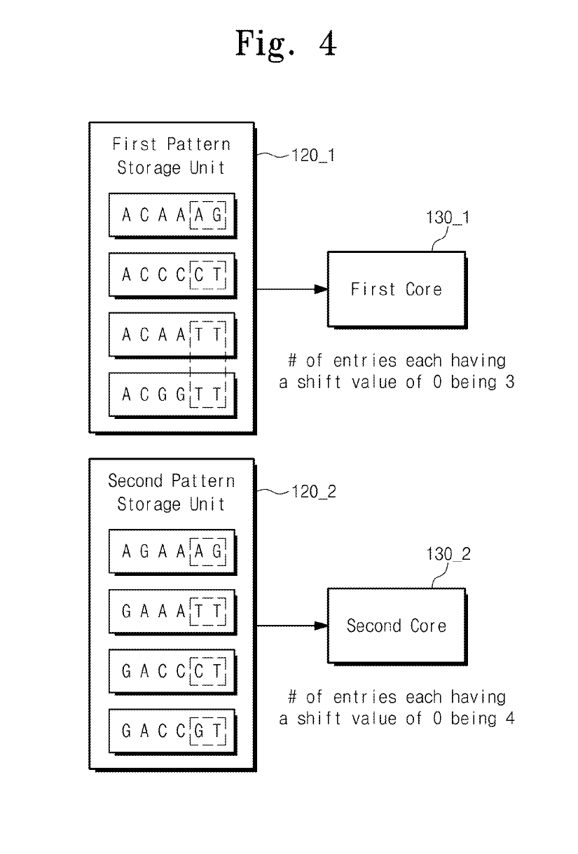

FIG. 3 is a diagram illustrating string matching on sorted patterns. FIG. 4 is a diagram illustrating string matching on unsorted patterns. For ease of description, it is assumed that two pattern storage units and two cores exist.

Referring to FIG. 3, patterns sorted by a pattern sorting module 110 of FIG. 2 may be allocated to first and second pattern storage units 120_1 and 120_2. That is, patterns ‘ACAAAG’, ‘AGAAAG’, ‘ACCCCT’, and ‘GACCCT’ may be stored at the first pattern storage unit 120_1, and patterns ‘GACCGT’, ‘ACAATT’, ‘ACGGTT’, and ‘GAAATT’ may be stored at the second pattern storage unit 120_2.

Referring to FIG. 4, patterns before sorting of the pattern sorting module 110 of FIG. 2 may be allocated to the first and second pattern storage units 120_1 and 120_2. That is, patterns ‘ACAAAG’, ‘ACCCCT’, ‘ACAATT’, and ‘ACGGTT’ may be stored at the first pattern storage unit 120_1, and patterns ‘AGAAAG’, ‘GAAATT’, ‘GACCCT’, and ‘GACCGT’ may be stored at the second pattern storage unit 120_2.

Referring to FIGS. 3 and 4, a first core 130_1 may perform string matching on patterns stored at the first pattern storage unit 120_1. A second core 130_1 may perform string matching on patterns stored at the second pattern storage unit 120_2. That is, string matching may be performed in parallel by the first and second cores 130_1 and 130_2.

As an embodiment of the inventive concept, a Wu-Manber algorithm may be applied to the string matching. By the Wu-Manber algorithm, after there is performed pre-processing for generating a shift table, a hash table, and a prefix table, string matching may be performed referring to tables generated at the pre-processing.

The shift table may have a shift value on any possible combinations of characters in a given pattern. Herein, the shift value may be a value indicating how many matching on characters can be skipped from a previous matching location to a next matching location. That is, the shift value may mean the number of characters for which string matching is skipped. If a shift value is ‘0’, string matching may be performed referring to the hash table and the prefix table. Thus, computation on string matching may be reduced in proportion to a decrease in the number of entries each indicating that a shift value is ‘0’.

Meanwhile, when a shift table is generated at pre-processing, each core may set a shift value to 0 with respect to a combination of the same characters as a suffix block of patterns. This will be more fully described with reference to FIGS. 3 and 4.

Referring to FIG. 3, patterns stored at the first pattern storage unit 120_1 may have two types of suffix blocks. Thus, at pre-processing, the first core 130_1 may generate a shift table where the number of entries each having a shift value of 0 is 2. And, patterns stored at the second pattern storage unit 120_2 may have two types of suffix blocks. Thus, at pre-processing, the second core 130_2 may generate a shift table where the number of entries each having a shift value of 0 is 2. As a result, the string matching device 100 may generate a shift table where the number of entries each having a shift value of 0 is 4 (2+2).

Referring to FIG. 4, patterns stored at the first pattern storage unit 120_1 may have three types of suffix blocks. Thus, at pre-processing, the first core 130_1 may generate a shift table where the number of entries each having a shift value of 0 is 3. And, patterns stored at the second pattern storage unit 120_2 may have four types of suffix blocks. Thus, at pre-processing, the second core 130_2 may generate a shift table where the number of entries each having a shift value of 0 is 4. As a result, the string matching device 100 may generate a shift table where the number of entries each having a shift value of 0 is 7 (3+4).

Comparing FIGS. 3 and 4, the number of entries, each having a shift value of 0, in a shift table on patterns sorted according to lexicographic order based on a suffix block (FIG. 3) may be less than the number of entries, each having a shift value of 0, in a shift table on unsorted patterns (FIG. 4). This may mean that computation on string matching by the Wu-Manber algorithm is reduced by sorting patterns according to lexicographic order by a suffix block.

Meanwhile, string matching by the Wu-Manber algorithm according to an embodiment of the inventive concept may be exemplary. For example, string matching may be executed by an Aho-Corasick algorithm.

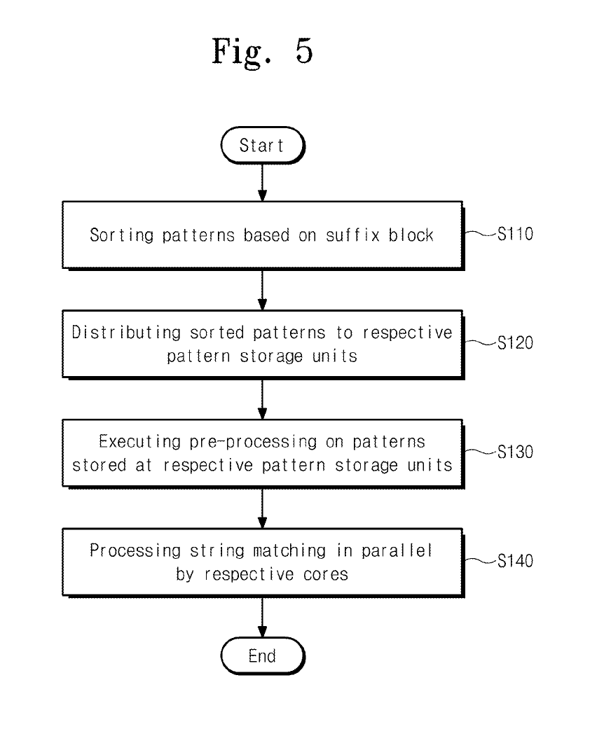

FIG. 5 is a flow chart illustrating a string matching method according to an embodiment of the inventive concept. Referring to FIG. 5, in operation S110, patterns may be sorted according to lexicographic order by a suffix block.

In operation S120, the sorted patterns may be allocated to pattern storage units, respectively. As described above, since the sorted patterns are allocated based on the suffix block, the probability that patterns having the same suffix block are stored at each pattern storage unit may be high. As described above, this may mean that computation at parallel processing of string matching is reduced.

In operation S130, patterns stored at each pattern storage unit may be pre-processed. At this time, pre-processing on cores may be performed in parallel. In the event that the Wu-Manber algorithm is applied, a shift table, a hash table, and a prefix table may be generated at pre-processing.

In operation S140, string matching on a target text may be performed referring to the tables generated at pre-processing. At this time, pre-processing on cores may be performed in parallel. Each core may access a shared data module to read the target text.

As described above, in the string matching method according to an embodiment of the inventive concept, pre-processing and string matching may be processed in parallel based on a multi-core processor. Thus, an operating speed may be improved in comparison with a string matching device based on a single-core processor. Also, patterns may be sorted according to lexicographic order based on a suffix block, and the sorted patterns may be allocated to pattern storage units, respectively. Thus, computation on string matching may be reduced.

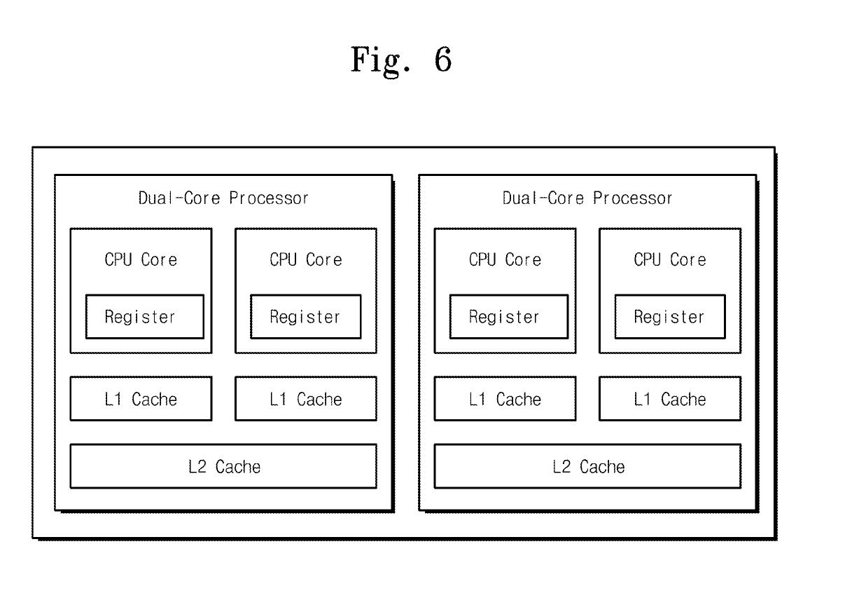

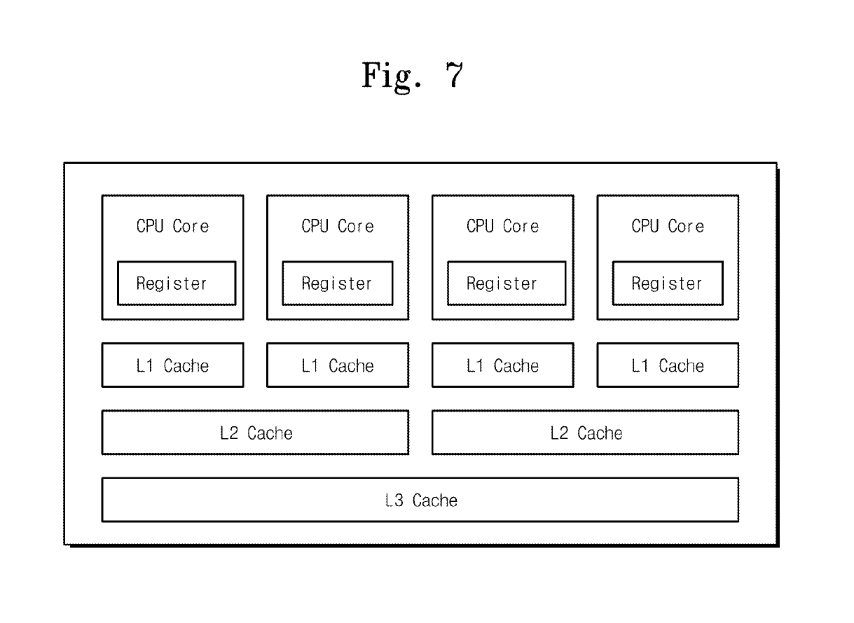

FIG. 6 is a block diagram illustrating a multi-core processor according to an embodiment of the inventive concept. FIG. 7 is a block diagram illustrating a multi-core processor according to another embodiment of the inventive concept.

Referring to FIG. 6, there may be illustrated a quad-core processor. A multi-core processor of FIG. 6 may be a central processing unit formed by integrating two dual-core processors to a single die. That is, the multi-core processor of FIG. 6 may have such a structure that two dual-core processors are integrated to a chip. Herein, a dual-core processor may be formed of two cores having the same architecture. Each core may share an L2 cache memory. On the other hand, L1 cache memories may be assigned to corresponding cores, respectively.

In the event that the multi-core processor of FIG. 6 is a string matching device, the L1 cache memory may be used as a pattern storage unit. A target text may be stored at the L2 cache memory. In this case, pre-processing on patterns stored at the L1 cache memory may be processed in parallel by cores. The respective cores may access the L2 cache memory to read a target text during execution of string matching.

Referring to FIG. 7, there may be illustrated a quad-core processor having a structure different from that of FIG. 6. A multi-core processor of FIG. 7 may include four cores having the same architecture. And, the multi-core processor of FIG. 7 may include an L3 cache memory.

In the event that the multi-core processor of FIG. 7 is a string matching device, the L2 cache memory may be used as a pattern storage unit. A target text may be stored at the L3 cache memory. In this case, pre-processing on patterns stored at the L2 cache memory may be processed in parallel by cores. The respective cores may access the L3 cache memory to read a target text during execution of string matching. Data generated at execution of string matching may be temporarily stored at the L1 cache memory.

As described above, a string matching device according to an embodiment of the inventive concept may be implemented by multi-core processors having various architectures. At this time, string matching may be processed in parallel by cores. Thus, the performance of the string matching device may be improved in proportion to an increase in the number of cores included in the multi-core processor.

Also, a string matching device according to an embodiment of the inventive concept may include a computer-readable storage medium. The computer-readable storage medium may include a program command, a data file, a data structure, or a combination thereof. For example, the computer-readable storage medium may include magnetic media (e.g., a hard disk drive, a floppy disk, a magnetic tape, etc.), optical media (e.g., CD_ROM, DVD, etc.), magneto-optical media (e.g., floptical disk and so on), or a hardware device (e.g., ROM, RAM, flash memory, etc.) which is configured to store and execute a program command.

A program command of the computer-readable storage medium may be specifically designed for the inventive concept or well known in a computer software field. For example, the program command may include a machine code which is made by a compiler or a high-level language code which is made by an interpreter to be executable by a computer.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

1. A string matching method based on a multi-core processor, comprising:
sorting patterns based on a suffix block;
allocating the sorted patterns to pattern storage units of respective cores; and
executing string matching on a target text using patterns stored at the pattern storage unit.

2. The string matching method of claim 1, wherein in the executing string matching, the string matching is executed by a Wu-Manber algorithm.

3. The string matching method of claim 2, wherein the executing string matching comprises:
executing pre-processing on patterns stored at each pattern storage unit; and
executing the string matching on the target text referring to tables generated at the pre-processing.

4. The string matching method of claim 3, wherein the executing pre-processing comprises generating a shift table, and
wherein when the shift table is generated, a shift value is set to ‘0’ on a combination of the same characters as a suffix block of patterns stored at each pattern storage unit.

5. The string matching method of claim 3, wherein in the executing pre-processing, the pre-processing is processed in parallel by the cores.

6. The string matching method of claim 3, wherein in the executing string matching, the string matching is processed in parallel by the cores.

7. The string matching method of claim 1, wherein in the sorting patterns, the patterns are sorted according to lexicographic order of characters included in the suffix block.

8. A string matching method based on a multi-core processor, comprising:
sorting patterns according to lexicographic order based on characters include in a suffix block;
allocating the sorted patterns to pattern storage units of respective cores;
executing pre-processing on patterns stored at the pattern storage unit; and
executing string matching on a target text referring to tables generated at the pre-processing.

9. The string matching method of claim 8, wherein in the executing pre-processing and the executing string matching, the pre-processing and the string matching are executed by a Wu-Manber algorithm.

10. The string matching method of claim 8, wherein in the executing pre-processing and the executing string matching, the pre-processing and the string matching are processed in parallel by the cores.

11. A string matching device comprising:
a pattern sorting module configured to sort patterns based on a suffix block;
first and second pattern storage units configured to store the sorted patterns; and
first and second pattern matching units corresponding to the first and second pattern storage units and configured to perform string matching on a target text using patterns stored at the first and second pattern storage units, respectively.

12. The string matching device of claim 11, further comprising:
a shared data storage module configured to store the target text, and
wherein the first and second pattern storage units access the shared data storage module to read the target text.

13. The string matching device of claim 12, wherein the first and second pattern matching units execute the string matching using a Wu-Manber algorithm.

14. The string matching device of claim 13, wherein the first and second pattern matching units perform pre-processing on patterns stored at the first and second pattern storage units, respectively, to generate a shift table, a hash table and a prefix table.

15. The string matching device of claim 14, wherein when the shift table is generated, each of the first and second pattern matching units sets a shift value to ‘0’ on a combination of the same characters as a suffix block of patterns stored at a corresponding one of the first and second pattern storage units.

16. The string matching device of claim 13, wherein the pre-processing and the string matching are processed in parallel by the first and second pattern matching units.

17. The string matching device of claim 16, wherein the first and second pattern matching units are implemented by a multi-core processor.

18. The string matching device of claim 11, wherein the pattern sorting module sorts the patterns according to lexicographic order of characters included in the suffix block.

19. The string matching device of claim 11, wherein the target text is a genome gene sequence.

20. The string matching device of claim 11, wherein a size of the suffix block is 2.
